(19) United States
(12) Patent Application Publication
(10) Pub. No.: US 2005/0087491 A1
(43) Pub. Date: Apr. 28, 2005

(54) Hybrid membrane, method for producing the same and use of said membrane

(75) Inventors: Volker Hennige, Duelmen (DE); Christian Hying, Rhede (DE); Gerhard Horpel, Nottuln (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: CREAVIS GESELLSCHAFT F. TECHN. U. INNOVATION MBH, Marl (DE)

(21) Appl. No.: 10/498,501

(22) PCT Filed: Jan. 15, 2003
(86) PCT No.: PCT/EP03/00330

(30) Foreign Application Priority Data
Feb. 26, 2002 (DE) 102 08 278.2

(51) Int. Cl. B01D 61/00

(52) U.S. Cl. 210/640; 95/45; 210/650; 210/652; 210/490; 210/500.27; 210/505; 210/508; 96/4

(57) ABSTRACT

A description is given of a hybrid membrane which combines the advantages of the inorganic membranes, such as solvent resistance and stability, with the advantages of the organic membrane materials. The hybrid membrane described is composed of a ceramic support layer which is applied on a support comprising polymer fibers, and an organic, selective layer. The separating properties of the membranes can be tailored by varying the polymers and/or the way in which the polymer materials are treated and/or the conditions under which the polymeric selective separating layer is produced.

The invention relates to a hybrid membrane comprising an organic/inorganic, permeable support material with an organic, selective separating layer.

Ceramic membranes have been known for more than 10 years and on account of their still fairly high price are employed where good temperature stability (>80° C.) or good chemical resistance is vital. These membranes are available commercially for microfiltration and for ultrafiltration applications. Additionally, there have recently been reports of various applications in pervaporation and in nanofiltration (K.-V. Peinemann and S. P. Nunes, Membrane Technology; 2001, VCH-Verlag).

The ceramic materials of the separating layers which are used in the last-mentioned applications are nanoparticulate and possess a very large surface area. This and the restriction to materials such as γ-alumina or silica dioxide mean that these membranes do not possess the required acid and/or alkali resistance. Reverse osmosis membranes and membranes which separate according to the solution-diffusion mechanism cannot be obtained from ceramic materials.

Polymeric membranes composed of a very wide variety of polymers are available at relatively favorable cost for wide pH ranges and for numerous applications. However, the majority of materials are not resistant to solvent and/or are not stable at temperatures above 80° C. for long periods of time.

At present, numerous investigations are ongoing into improving these properties of polymer membranes, and new polymer materials with an extended range of use are continually being developed as well. Nevertheless, there are two hurdles which stand in the way of any marked expansion of the field of use of the polymer membranes. First, no sufficiently stable polymeric support materials such as support nonwovens are available, and second all polymers are plastically deformable at elevated temperatures. This results in compaction of the membranes as a whole when they are operated under pressure loads at elevated temperatures. Said compaction goes so far that the pore microstructure of the membrane is completely pressed together, after which filtrate finds it virtually impossible to pass through the membrane. When such membranes are used in a middle temperature range, there is a drastic drop in flow which has to be accepted by the users.

A further disadvantage of the membranes based on polymer materials is that they can be partially or fully dissolved by solvents or oils or that the oils have a plasticizing effect. These three effects all result either in the separation capacity of the membrane being adversely affected or in the membrane undergoing compaction even at very low temperatures. Ultimately, the inevitable result of compaction is that the membrane exhibits a reduced flow performance or becomes unusable on account of inadequate flow.

It can therefore be stated that polymeric membrane materials are capable of a very much higher performance that that currently exhibited by the polymeric membranes. The weak point of the polymeric membranes is not the materials or the selective layers. These can be tailored for the particular separation by skillful selection of the materials and by chemical modification. The weakness of the polymeric membranes is the polymeric supporting structure of the membranes. The asymmetric polymeric support membranes (with pore sizes of up to 5 μm) do not stand up to the requirements.

In DE 199 12 582 an attempt is made to increase the stability of the membranes by incorporating into the polymer matrix an inorganic metal oxide powder which enhances the stability. Admixing the inorganic filler ensures that the pore structure of the membrane is maintained even when it is dried more quickly than is otherwise customary in a stream of air, for example. Compaction of the membrane at elevated temperatures, however, is not prevented by this method.

WO 99/62620 discloses an ion-conducting composite which can be used as a membrane, the ion conduction being achieved, inter alia, by adding ion-conducting polymers to the composite. However, these polymers are not in the form of an actively separating layer but instead, to allow conduction to take place, extend through the entire pores from one side of the composite to the other.

WO 99/62624 describes composites which have hydrophobic properties and can be used as a membrane, these composites possibly having polymers on the internal and external surfaces. These polymers do not constitute the actively separating layer but instead serve to produce hydrophobicity in the composite. During the preparation of these composites, the polymers are added to the sol from which a suspension is prepared which is applied to a support and solidified. In this way, the polymer is distributed over the entire cross section of the composite. The pore size of this composite is determined by the inorganic particles.

DE 101 39 559 for the first time describes a hybrid membrane having a selective separating layer, the membrane comprising an inorganic, permeable support material and polymeric material, said membrane being characterized in that the selective separating layer is formed by the polymeric material. In that application, the support material is composed of glass microfiber nonwovens, metal nonwovens, impervious glass fiber wovens or metal wovens, but also ceramic or carbon fiber nonwovens or wovens which have been given a ceramic coating. Although such membranes have the positive separating properties of a polymer membrane, and also possess relatively high stability at elevated temperatures and on exposure to oils or solvents, they are not particularly stable to mechanical stress. Moreover, the nonwovens and wovens used are very expensive.

It was therefore an object of the present invention to develop a membrane which has the positive separating properties of a polymer membrane, which has sufficiently great stability at elevated temperatures and on exposure to oils or solvents, which can be manufactured inexpensively, and which has a markedly higher stability toward mechanical loads.

Surprisingly it has been found that a hybrid membrane which comprises a polymeric separating layer and an organic/inorganic ceramic support composite possesses the separating properties of a polymer membrane and to a very large extent the chemical resistance and pressure resistance of a ceramic membrane. It has also surprisingly been found that the methods of preparing polymeric membranes can be applied very readily to a flexible, organic/inorganic, chemically resistant and pressure-stable support material.

The present invention accordingly provides a hybrid membrane as claimed in claim 1, having a selective separating layer and comprising a permeable composite and polymeric material, wherein the selective separating layer is formed by the polymeric material and the composite is based on a permeable support which comprises polymer fibers and on which and/or in which there are inorganic components.

The present invention also provides a process for producing a hybrid membrane having a selective separating layer and comprising a permeable composite and polymeric material, the selective separating layer being formed by the polymeric material and the composite being based on a permeable support which comprises polymer fibers and on which and/or in which there are inorganic components, which comprises applying a solution of an organic polymer to the inorganic composite and forming a polymer layer on the composite.

The present invention further provides for the use of a hybrid membrane of the invention as a membrane in pressure-operated membrane processes, in nanofiltration, reverse osmosis or ultrafiltration, in pervaporation and/or in vapor permeation, in a membrane reactor or as a membrane in gas separation.

The hybrid membranes of the invention have the advantage that their temperature stability and dimensional stability is significantly greater than that of pure organic polymer membranes, polymer membranes on polymer supports or polymer membranes to which inorganic substances have been admixed. In particular, in the case of the membranes of the invention, the desired selectivity and the flow through the separating layer is retained even at temperatures of up to 150° C. and even at relatively high pressure; in other words, the unwanted phenomenon of membrane compaction is prevented. Moreover, the hybrid membranes of the invention are tolerant of chemicals and in particular are stable toward the common solvents.

The hybrid membrane of the invention further comprises an organic/ceramic support structure which is based on ceramic-coated polymer fibers and which is thin and flexible, so that the hybrid membrane is likewise flexible. In terms of the choice of the modules and housings, therefore, the hybrid membranes involve virtually no restrictions whatsoever compared with pure polymer membranes. As a result of the pronounced flexibility of the hybrid membrane of the invention, it withstands mechanical loads very much better than hybrid membranes based on inorganic supports.

The hybrid membranes of the invention have the advantage, moreover, that they are extremely favorable to produce, since polymer wovens or nonwovens are much more favorable than metal or glass nonwovens or wovens of these materials. In contrast to glass fibers, moreover, the polymer fibers are much less brittle, thereby likewise greatly simplifying the handling of the starting material and so making it more favorable.

The hybrid membrane of the invention is described by way of example below, without any intention that the invention should be restricted to these embodiments.

The hybrid membrane of the invention, having a selective separating layer and comprising a permeable composite and polymeric material, has the distinctive features that the selective separating layer is formed by the polymeric material and the composite is based on a permeable support which comprises polymer fibers and on which and/or in which there are inorganic components. The inorganic components form a porous ceramic coating.

The hybrid membranes of the invention preferably comprise composites which comprise a flat, multiapertured, flexible substrate having a coating on and in said substrate, the material of the substrate being selected from woven and nonwoven fibers of polymers and the coating being a porous ceramic coating. It can be advantageous if the hybrid membranes comprise composites which have a thickness of less than 200 μm. The hybrid membranes preferably comprise permeable composites having a thickness of less than 100 μm, with particular preference a thickness of from 20 to 100 μm.

As a result of the low thickness of the composite, the thickness of the hybrid membrane is also very low. The low thickness of the hybrid membrane allows a high transmembrane flow.

The material of the substrate is selected from woven and nonwoven polymer fibers and natural fibers. Woven polymer fibers and/or natural fibers can, for example, be woven fabrics. Nonwoven polymer and/or natural fibers can, for example, be knits, webs or felts. With particular preference, the material of the flexible substrate is a web of polymer fibers or a web comprising polymer fibers. Through the use of a web, preferably a very thin and homogeneous web material, a uniform transmembrane flow is obtained. Webs have the advantage, moreover, that their porosity is much higher than that of comparable woven fabrics.

The composite preferably comprises a substrate which has a thickness of from 10 to 200 μm. It can be particularly advantageous if the composite comprises a substrate which has a thickness of from 30 to 100 μm, preferably from 25 to 50 μm, and with particular preference from 30 to 40 μm. The low thickness of the substrate used, as well, ensures that the transmembrane flow through the composite and hence through the membrane is greater than in the case of conventional membranes.

The polymer fibers are preferably selected from polyacrylonitrile, polyamides, polyimides, polyacrylates, polytetrafluoroethylene, polyesters, such as polyethylene terephthalate and/or polyolefins, such as polypropylene, polyethylene or mixtures of these polymers. However, all other known polymer fibers and many natural fibers, such as flax fibers, coffon or hemp fibers, are also conceivable. The membrane of the invention preferably comprises polymer fibers which have a softening temperature of more than 100° C. and a melting temperature of more than 110° C. With polymer fibers having lower temperature limits, there is also a reduction in the fields of application. Preferred membranes can be used at a temperature of up to 150° C., preferably up to from 120 to 150° C., and with very particular preference up to 121° C. It can be advantageous if the polymer fibers of the substrate of the composite have a diameter of from 1 to 25 μm, preferably from 2 to 15 μm. Where the polymer fibers are markedly thicker than the stated ranges, the flexibility of the substrate suffers and hence also that of the membrane.

For the purposes of the present invention, the term “polymer fibers” embraces fibers of polymers which have been partially modified structurally or chemically by a thermal treatment, such as partly carbonized polymer fibers, for example.

The ceramic coating on and in the substrate preferably comprises an oxide of the metals Al, Zr, Si, Sn, Ti and/or Y. With particular preference, the coating on and in the substrate comprises an oxide of the metals Al, Zr, Ti and/or Si as inorganic component.

Within the coating there is preferably at least one inorganic component in a fraction having a particle size of from 1 to 250 nm or having a particle size of from 251 to 10 000 nm. It can be advantageous if the membrane of the invention has a coating which comprises at least two particle size fractions of at least one inorganic component. It may likewise be advantageous if the coating comprises at least two particle size fractions of at least two inorganic components. The particle size ratio can be from 1:1 to 1:10 000, preferably from 1:1 to 1:100. The ratio of the particle size fractions in the composite can be preferably from 0.01:1 to 1:0.01.

It may be advantageous if the ceramic coating and/or the inorganic components which make up the coating of the composite are attached to the substrate, in particular the polymer fibers, by way of adhesion promoters. Typical adhesion promoters are organofunctional silanes, as offered, for example, by Degussa under the trade name “Dynasilans”, although pure oxides such as ZrO₂, TiO₂, SiO₂ or Al₂O₃ may be suitable adhesion promoters for some fiber materials. Depending on production conditions and on the adhesion promoter used, the adhesion promoters may still be detectably present in the membrane of the invention.

It may be advantageous if the web or woven material has first been coated with an adhesion promoter. Accordingly, such a membrane then has in its interior a web, preferably a polymer web, whose fibers are finished with a thin layer of an adhesion promoter (such as a metal oxide or an organosilane compound, for example). In and on the polymeric precoated support there is the porous ceramic material.

As its separating layer, the hybrid membrane of the invention may comprise a gastight polymer layer. In the context of the present invention, gastight means that a gas is unable to pass in laminar flow through the separating layer. Instead, the separation of gas mixtures, for example, at the separating layer is accomplished by the gases of the gas mixture to be separated diffusing or being transported through the membrane at different rates.

The gastight polymer layer may be composed, for example, of polydimethylsiloxane (PDMS), polyvinyl alcohol, methylcellulose, polyimide, polyamide, polyurethane, polyester, polyether or copolymers, including block copolymers, of these polymers or cellulose acetate or a polymer blend which comprises at least one of said compounds, or may comprise these compounds or modifications thereof. Furthermore, the polymeric starting substances for forming the gastight layers may contain crosslinkable groups, especially UV-crosslinkable or thermally crosslinkable groups. It is also possible for the gastight polymer layers to comprise inorganic adjuvants such as zeolites, polyacids, zeolites such as ZSM-5, mordenite or zeolite Y, and also metal salts, which influence the separating properties of the polymer layer in a desired way—for example, by raising the sorption of preferred compounds (hydrophiles in the case of polyacids, mordenite, zeolite Y, and metal salts, or hydrophobes in the case of the ZSM-5 zeolite). The fraction of inorganic adjuvants in the gastight polymer layers is preferably less than 20% by weight, more preferably less than 10% by weight, and with very particular preference less than 5% by weight.

The hybrid membranes of the invention preferably have a polymer layer with a thickness of from 0.1 to 10 μm, preferably from 0.2 to 5 μm. Preferred gastight polymer layers have thicknesses of less than 5 μm, preferably from 0.1 to 3.75 μm, and with very particular preference from 0.3 to 2.75 μm.

A feature of the membranes of the invention is that they have a tensile strength of at least 1 N/cm, preferably of 3 N/cm, and with very particular preference of greater than 6 N/cm. The membranes of the invention are preferably flexible and can preferably be bent without damage by any radius down to 100 m, preferably down to 50 mm, and with very particular preference down to 2 mm. The good bendability of the membrane of the invention has the advantage that when it is used in filtration, pervaporation or gas separation, sudden pressure fluctuations can be borne without problems by the membrane without it being damaged.

The hybrid membrane of the invention is preferably produced by means of the process of the invention for producing a hybrid membrane having a selective separating layer and comprising a permeable composite and polymeric material, the selective separating layer being formed by the polymeric material and the composite being based on a permeable support which comprises woven or nonwoven polymer fibers and on which and in which there are inorganic components, said process comprising applying a layer comprising an organic polymer to the composite. This can be done, for example, by applying a solution of an organic polymer to the inorganic composite and forming a polymer layer on the composite. Furthermore, it is also possible to apply polymer layers formed by interface polycondensation, or thin polymer layers produced on the surfaces of fluids, to the composite. This can be carried out by guiding the composite material to be coated out of the fluid, or the lower phase in the case of interface polycondensation, through the polymer layer, so that said layer attaches to the top face. After drying, the coated membrane can then be wound up.

The process can be implemented in a variety of ways. The process is preferably implemented in the plants and equipment which are known from the prior art for producing polymer membranes, with the difference that the permeable composite is used instead of the polymeric support membrane. This composite is preferably of a nature such that the pores, meshes and/or apertures are less than 2 μm in diameter. With particular preference, the composite is flexible and has a correspondingly good tensile strength in the machine direction, preferably a tensile strength of at least 1 N/cm, with particular preference at least 3 N/cm. With very particular preference, the composite has a tensile strength of at least 6 N/cm in the machine direction, especially when polymer fiber webs are used as the substrate of the composite.

The use of composites of high tensile strength means that the hybrid membrane as well shares the high tensile strength of the composite.

As composites it is preferred to use membranes, especially microfiltration and ultrafiltration membranes, which are obtainable, for example, by the process described below. These membranes are obtainable by a process which comprises providing a flat, multiapertured, flexible substrate with a coating in and on said substrate, the material of the substrate being selected from webs of polymer fibers or natural fibers, the webs preferably having a porosity of more than 50% and the coating being a porous ceramic coating which is applied to the substrate by applying a suspension comprising at least one oxide of the metals Al, Zr, Si, Sn, Ti and/or Y and a sol to the substrate and by heating the coated substrate at least once, in the course of which the suspension on and in the substrate is solidified. The suspension may comprise further inorganic components, especially of a kind such as have already been described above as inorganic components.

The suspension can be applied on and in the substrate, for example, by printing, pressing, injecting, rolling, knife coating, spreading, dipping, spraying or pouring.

The material of the substrate is preferably selected from webs of polymer fibers having a thickness of from 10 to 200 μm. It can be particularly advantageous if the membrane of the invention comprises a substrate which has a thickness of from 30 to 100 μm, preferably from 25 to 50 μm.

The polymer fibers are preferably selected from polyacrylonitrile, polyamides, polyimides, polyacrylates, polytetrafluoroethylene, polyesters, such as polyethylene terephthalate and/or polyolefins. However, all other known polymer fibers and many natural fibers are also conceivable. The membrane preferably comprises polymer fibers which have a softening temperature of more than 100° C. and a melting temperature of more than 110° C. With polymer fibers having lower temperature limits, there is also a reduction in the fields of application. Preferred membranes can be used at a temperature of up to 150° C., preferably up to from 120 to 150° C., and with very particular preference up to 121° C. It can be advantageous if the polymer fibers have a diameter of from 1 to 25 μm, preferably from 2 to 15 μm. Where the polymer fibers are markedly thicker than the stated ranges, the flexibility of the substrate suffers and hence also does that of the membrane.

The suspension used to prepare the coating, which comprises at least one inorganic component, preferably comprises at least one inorganic oxide of aluminum, titanium, silicon and/or zirconium and at least one sol, at least one semimetal oxide sol or at least one mixed metal oxide sol or a mixture of these sols and is prepared by suspending at least one inorganic component in at least one of said sols.

The sols are obtained by hydrolyzing at least one compound, preferably at least one metal compound, at least one semimetal compound or at least one mixed metal compound. The compound to be hydrolyzed is preferably at least one metal nitrate, metal chloride, metal carbonate, metal alkoxide compound or semimetal alkoxide compound, with particular preference at least one metal alkoxide compound. As the metal alkoxide compound or semimetal alkoxide compound it is preferred to hydrolyze an alkoxide compound of the elements Zr, Al, Si, Ti, Sn and Y or at least one metal nitrate, metal carbonate or metal halide selected from the metal salts of the elements Zr, Al, Ti, Si, Sn, and Y, as the metal compound. The hydrolysis takes place preferably in the presence of water, steam, ice or an acid or a combination of these compounds.

In one variant of the process of the invention, particulate sols are prepared by hydrolyzing the compounds to be hydrolyzed. A feature of these particulate sols is that the compounds formed in the sol by hydrolysis are in particulate form. The particulate sols may be prepared as above or as described in WO 99/15262. These sols normally have a very high water content, which is preferably greater than 50% by weight. It can be advantageous to add the compound to the hydrolyzed, prior to hydrolysis, to alcohol or an acid or a combination of these liquids. The hydrolyzed compound can be peptized by treatment with at least one organic or inorganic acid, preferably with an organic or inorganic acid having a strength of from 10 to 60%, with particular preference with a mineral acid selected from sulfuric acid, hydrochloric acid, perchloric acid, phosphoric acid, and nitric acid, or with a mixture of these acids. The particulate sols thus prepared can then be used to prepare suspensions, preference being given to the preparation of suspensions for applying to natural fiber webs or polymer fiber webs pretreated with polymeric sol.

In another variant of the process of the invention, polymeric sols are prepared by hydrolysis of the compounds to be hydrolyzed. A feature of these polymeric sols is that the compounds formed in the sol by hydrolysis are in polymeric form (that is, crosslinked in chain form over a relatively large three-dimensional area). The polymeric sols customarily have a water and/or aqueous acid content of less than 50% by weight, preferably very much less than 20% by weight. In order to arrive at the preferred fraction of water and/or aqueous acid, the hydrolysis is preferably conducted by hydrolyzing the compound to be hydrolyzed with from 0.5 to 10 times the molar ratio and more preferably with half the molar ratio of water, steam or ice, based on the hydrolyzable group of the hydrolyzable compound. An amount of water up to 10 times the amount can be used in the case of compounds which hydrolyze very slowly, such as tetraethoxysilane, for example. Compounds which hydrolyze very rapidly, such as zirconium tetraethoxide, may well already form particulate sols under these conditions, which is why it is preferred to use 0.5 times the amount of water to hydrolyze such compounds. Hydrolysis with less than the preferred amount of water, steam or ice likewise leads to good results. While going below the preferred amount of half the molar ratio by more than 50% is possible, it is not very advisable since below that figure the hydrolysis is no longer complete and coatings based on such sols are not very stable.

In order to prepare these polymeric sols with the desired, very low fraction of water and/or acid in the sol, it can be advantageous if the compound to be hydrolyzed is dissolved in an organic solvent, especially ethanol, isopropanol, butanol, amyl alcohol, hexane, cyclohexane, ethyl acetate and/or mixtures of these compounds, before performing the actual hydrolysis. The sol thus prepared can be used for preparing the suspension of the invention or as an adhesion promoter in a pretreatment step.

Both the particulate sols and the polymeric sols can be used as the sol in the process of the invention for preparing the suspension. In addition to the sols obtainable as just described, it is also possible in principle to use commercial sols, such as zirconium nitrate sol or silica sol. The process of producing membranes by applying and solidifying a suspension on a support, per se, is known from WO 99/15262, although not all of the parameters and substances used can be transferred to the production of the membrane of the invention. The operation which is described in WO 99/15262 is in this form in particular not transferable to the polymeric web materials without curtailments, since the very aqueous sol systems described therein frequently do not allow thorough wetting of the normally hydrophobic polymer webs deep down, on account of the fact that the wetting of the majority of polymer webs by the very aqueous sol systems is poor or indeed absent. It has been found that even very small unwetted areas in the web material may lead to the obtention of membranes which has defects and are therefore unusable.

It has now surprisingly been found that a sol system or a suspension which has been adapted to the polymers in terms of its wetting properties completely pervades the web materials and so makes it possible to obtain defect-free coatings. In the process of the invention, therefore, the wetting properties of the sol or suspension are preferably adapted. This adaptation takes place preferably through the preparation of polymeric sols or suspensions of polymeric sols, these sols comprising one or more alcohols, such as methanol, ethanol or propanol, for example, or mixtures which comprise one or more alcohols and also preferably aliphatic hydrocarbons. However, other solvent mixtures are conceivable for addition to the sol or suspension in order to adapt its wetting properties to the substrate used.

It has been found that the fundamental alteration of the sol system and of the resultant suspension leads to a marked improvement in the adhesion properties of the ceramic components on and in a polymeric web material. Such good adhesive strengths are not normally obtainable with particulate sol systems. Substrates comprising polymer fibers are therefore preferably coated with suspensions which are based on polymeric sols or which in a step beforehand have been finished with an adhesion promoter by treatment with a polymeric sol.

It can be advantageous if the suspension is prepared by suspending, as inorganic component, at least one oxide selected from the oxides of the elements Y, Zr, Al, Si, Sn, and Ti in a sol. As the inorganic component it is preferred to suspend at least one compound selected from aluminum oxide, titanium dioxide, zirconium oxide and/or silicon dioxide. The mass fraction of the suspended component is preferably from 0.1 to 500 times, with particular preference from 1 to 50 times, and with very particular preference from 5 to 25 times that of the sol which is used.

It can be advantageous if at least one inorganic component which has an average particle size of from 1 to 10 000 nm, preferably from 1 to 10 nm, from 10 to 100 nm, from 100 to 1 000 nm or from 1 000 to 10 000 nm, with particular preference from 250 to 1 750 nm, and with very particular preference from 300 to 1 250 nm, is suspended in at least one sol. Through the use of inorganic components which have an average particle size of from 250 to 1 250 nm the flexibility and porosity achieved in the membrane are especially suitable.

For the purpose of improving the adhesion of the inorganic components to polymer fiber substrates, it can be advantageous to add adhesion promoters, such as organofunctional silanes or else pure oxides such as ZrO₂, TiO₂, SiO₂ or Al₂O₃, to the suspensions used. Addition of the adhesion promoters to suspensions based on polymeric sols is especially preferred. Adhesion promoters which can be used are, in particular, compounds selected from octylsilanes, fluorinated octylsilanes, vinylsilanes, amine-functionalized silanes and/or glycidyl-functionalized silanes, such as the Dynasilans from Degussa. Particularly preferred adhesion promoters for polytetrafluoroethylene (PTFE) are, for example, fluorinated octylsilanes; for polyethylene (PE) and polypropylene (PP) they are vinylsilanes, methylsilanes and octylsilanes, although exclusive use of methylsilanes is not optimal; for polyamides and polyamines they are amine-functional silanes; for polyacrylates and polyesters they are glycidyl-functionalized silanes, and for polyacrylonitrile it is also possible to use glycidyl-functionalized silanes. Other adhesion promoters can also be used but must be attuned to the respective polymers. The addition of methyltriethoxysilane to the sol system during the coating of polymeric supporting materials, which is described in WO 99/15262, is a comparatively poor solution to the problem of the adhesive strength of ceramic on polymer fibers. Moreover, the drying time of from 30 to 120 minutes at from 60 to 100° C. for the sol systems described is insufficient to give ceramic materials which are stable to hydrolysis. Accordingly, on prolonged storage in aqueous media, these materials will dissolve or become damaged. Then again, the temperature treatment of more than 350° C. that WO 99/15262 describes would lead to combustion of the polymer web used here and would therefore result in the destruction of the membrane. Accordingly, the adhesion promoters must be selected such that the solidification temperature is below the melting or softening point of the polymer and below its decomposition temperature. Suspensions of the invention preferably contain much less than 25% by weight, preferably less than 10% by weight, of compounds which can act as adhesion promoters. An optimum proportion of adhesion promoter is given by the coating of the fibers and/or particles with a monomolecular layer of the adhesion promoter. The amount of adhesion promoter in grams required for this purpose can be obtained by multiplying the amount of oxides employed or the amount of fibers (in g) by the specific surface area of the materials (in m² g⁻¹) and then dividing the result by the specific occupancy of the adhesion promoters (in m² g⁻¹), the specific occupancy frequently being situated within the order of magnitude of from 300 to 400 m² g⁻¹.

The table below gives an exemplary overview of adhesion promoters based on organofunctional Si compounds which can be used for typical polymers used as web material.

| Polymer | Type of organic function | Adhesion promoter |
|---|---|---|
| PAN | glycidyl | GLYMO |
| | methacryloyl | MEMO |
| PA | amino | AMEO, DAMO |
| PET | methacryloyl | MEMO |
| | vinyl | VTMO, VTEO, VTMOEO |
| PE, PP | amino | AMEO, AMMO |
| | vinyl | VTMO, VTEO, Silfin |
| | methacryloyl | MEMO |

Key:
AMEO = 3-aminopropyltriethoxysilane
DAMO = 2-aminoethyl-3-aminopropyltrimethoxysilane
GLYMO = 3-glycidyloxytrimethoxysilane
MEMO = 3-methacryloyloxypropyltrimethoxysilane
Silfin = vinylsilane + initiator + catalyst
VTEO = vinyltriethoxysilane
VTMO = vinyltrimethoxysilane
VTMOEO = vinyltris(2-methoxyethoxy)silane

The coatings of the invention are applied to the substrate by solidifying the suspension in and on the substrate. In accordance with the invention, the suspension on and in the substrate can be solidified by heating at from 50 to 350° C. Since when using polymeric substrate materials the maximum temperature is determined by the substrate, it must be adapted accordingly. Thus depending on the particular variant of the process of the invention the suspension on and in the substrate is solidified by heating at from 100 to 350° C. and with very particular preference by heating at from 110 to 280° C. It can be advantageous if the heating takes place at a temperature of from 100 to 350° C. for from 1 second to 60 minutes. With particular preference the heating of this suspension for solidification takes place at a temperature from 110 to 300° C., with very particular preference at a temperature from 110 to 280° C., and preferably for from 0.5 to 10 minutes.

Depending on the level of temperature chosen, under the effect of temperature during the solidification of the membrane some polymer materials may undergo changes in chemical structure, so that subsequently the polymers are no longer in their initial state or modification. For instance, there may be partial carbonization of polyimides or formation of what are known as ladder polymers in the case of polyacrylonitrile, with subsequent partial carbonization. These effects always lead to a change in the properties of the support materials. Depending on application this may also be specifically intended, since by this means it is possible, for example, to raise the resistance to solvents, acids, and alkalis. The degree of the transformation can be influenced by way of temperature and time.

The inventive heating of the assembly can take place by means of heated air, hot air, infrared radiation or by other heating methods in accordance with the prior art.

In one particular embodiment of the process of the invention, the abovementioned adhesion promoters are applied to the substrate, especially the polymer web, in a preceding step. For this purpose they are dissolved in a suitable solvent, such as ethanol. This solution may also contain a small amount of water, preferably from 0.5 to 10 times the amount based on the molar amount of the hydrolyzable group, and small amounts of an acid, such as HCl or HNO₃, as a catalyst for the hydrolysis and condensation of the Si—OR groups. The solution is applied to the substrate with the known techniques, such as spraying, printing, pressing, injecting, rolling, knife coating, spreading, dipping, squirting or pouring, and the adhesion promoter is fixed on the substrate by means of a temperature treatment at from 50 to not more than 350° C. In this variant of the process of the invention, the suspension is not applied and solidified until after the adhesion promoter has been applied.

In another variant of the process of the invention, adhesion-promoting layers are applied in a pretreatment step in which a polymeric sol is applied and solidified The polymeric sol is preferably applied and solidified in the same way as the suspensions. The application of these polymeric sols finishes the substrates, especially the polymer webs, with an adhesion-promoting oxide of Al, Ti, Zr or Si, the substrate thereby being made hydrophilic. Substrates finished in this way can then be provided with a porous coating in accordance with the prior art described in WO 99/15262 or else as described above, the pretreatment making it possible to observe a markedly improved adhesion of the coating, particularly to polymer webs.

A typical polymeric sol for a pretreatment is, for instance, an alcoholic solution of a metal oxide (such as titanium ethoxide or zirconium propoxide, for example) with a strength of from 2 to 10% by weight which may further contain from 0.5 to 10 mol fractions of water and also small amounts of an acid catalyst. Following application of such a sol to a substrate, the substrates, preferably polymer webs, are treated at a temperature of not more than 350° C. This produces an impervious film of a metal oxide around the substrate fibers, thereby making it possible to infiltrate the substrate with a suspension or slip based on a commercial zirconium nitrate sol or silica sol without wetting difficulties.

Since polymeric sols form impervious films more readily than particulate sols and since, moreover, the particulate sols always possess relatively large amounts of water in the pore microstructure of the interparticulate volumes, it is easier to dry polymeric sols than particulate sols. Nevertheless, the membranes must be dried at temperatures of more than 150° C. so that the ceramic material acquires a sufficiently good strength of adhesion to the support. Particularly good adhesive strengths can be obtained at a temperature of at least 200° C., and especially good strengths at a temperature of at least 250° C. However, it is then absolutely necessary to use polymers possessing appropriate temperature stability for this purpose, such as polyethylene terephthalate (PET), polyacrylonitrile (PAN), polytetrafluoroethylene (PTFE), polyvinylidene fluoride (PVDF) or polyamide (PA), for instance. Where the support lacks sufficient temperature stability, the membrane can be initially presolidified by predrying at a relatively low temperature (up to 100° C.). In the course of subsequent solidification at an elevated temperature the ceramic layer then acts as a prop for the support, so that the substrate can no longer melt away. These process parameters do not apply only to the application and solidification of a polymeric sol, for example, as adhesion promoter but also to the application and solidification of suspensions based on polymeric sols.

Both modes of applying an adhesion promoter before actually applying the suspension make it possible to enhance the adhesion behavior of the substrates, particularly with regard to aqueous particulate sols, which is why substrates pretreated in this way in particular can be coated in accordance with the invention with suspensions based on commercial sols, such as zirconium nitrate sol or silica sol, for example. This procedure for applying an adhesion promoter also means, however, that the production process of the membrane of the invention must be extended by an intermediate treatment step or a pretreatment step. This is feasible, albeit more complicated than using adapted sols to which adhesion promoters have been added, but also has the advantage that better results are achieved even when using suspensions based on commercial sols.

The process of the invention can be carried out, for example, by unrolling the substrate from a roll, passing it at a speed of from 1 m/h to 2 m/s, preferably at a speed of from 0.5 m/min to 20 m/min, and with very particular preference at a speed from 1 m/min to 5 m/min, through at least one apparatus which applies the suspension on and in the support, such as a roller, for example, and at least one further apparatus which allows the suspension to be solidified on and in the support by heating, such as an electrically heated oven, for example, and rolling up the membrane thus produced on a second roll. In this way it is possible to produce the membrane of the invention in a continuous process. The pretreatment steps can also be carried out in the continuous process, with the parameters specified being observed.

As the composite it is preferred to use those materials or membranes which have average pore widths of less than 1 μm, in particular less than 500 nm and with very particular preference less than 100 nm.

The limitation to a very low pore width for the composites used is advantageous on account of the fact that excessively large pores would draw the polymer solution too far into the membranes by suction, leading to an unnecessarily large flow resistance in the finished membrane. However, excessively small pores may also have an adverse effect, since in certain cases they make the adhesion of the polymer layer too low and, during the application, there is delamination and hence complete destruction of the membranes. For this reason, the composites used with preference have a pore width of from 1 to 1 000 nm, preferably from 2 to 500 nm, and with very particular preference from 3 to 100 nm.

As already described, in accordance with one preferred embodiment of the process of the invention the composite can be coated with a solution which comprises at least one polymer. For the production of the hybrid membranes, the composite can be coated with a solution in accordance with the prior art by knife coating, spraying, rolling, printing or by dip coating techniques. The thickness in which the polymer solution is applied is preferably less than 300 μm, with particular preference less than 200 μm, and with very particular preference less than 100 μm. The application thickness may be influenced, for example, by what are known as recoating systems.

The polymer layer is formed by removing the solvent at a temperature from 50 to 350° C., preferably at a temperature from 50 to 125° C., from 126 to 250° C. or from 251 to 350° C., and with particular preference at a temperature from 80 to 160° C. The polymer solution used is preferably a solution of polydimethylsiloxane (PDMS), polyvinyl alcohol, methylcellulose, polyamide, polyimide, polyether, polyurethane, polyester or copolymers, including block copolymers, of these polymers or cellulose acetate or a polymer blend which comprises at least one of said compounds or else said compounds or modifications thereof. Suitable solvents are the known solvents which are capable of dissolving the stated polymers, such as toluene, petroleum fractions, THF, alcohols, for example, and also water and other known solvents. The solutions used, comprising at least one polymer, contain preferably from 0.1 to 10% by weight, with particular preference from 0.5 to 5% by weight, of polymer and/or cellulose acetate. In addition to the polymers it may be advantageous if the polymer solution includes compounds or components which allow the polymers to be crosslinked during the formation of a film or layer but also after the formation of a layer. As crosslinkers or crosslinker systems it is possible to use the crosslinker systems or crosslinkers which are known to be suitable for crosslinking the stated polymers. Examples of typical crosslinkers are compounds such as peroxides, for example, or compounds containing epoxide groups or diisocyanate groups.

The polymer or polymer material which is used to form the polymer layer may be chemically modified by means, inter alia, of the stated temperature treatments but also by an additional temperature treatment. Such a chemical modification may be, for example, a crosslinking reaction or a partial pyrolysis accompanied by crosslinking of the polymer. This subsequent modification of the polymer has the result that the polymer layer becomes insoluble in the majority of solvents. A subsequent crosslinking reaction as a means of chemical modification may also be initiated by irradiation with electrons or other forms of radiation, such as by UV irradiation, if the initial polymer layers contain UV-crosslinkable groups, or by means of low-energy electron beams.

In one likewise-preferred embodiment of the process of the invention, the coating of the composite with a polymer layer which has been produced by means of interface polycondensation or on the surface of a fluid for the purpose of producing a hybrid membrane takes place by guiding a composite from the fluid or from the lower phase in the case of interface polycondensation, the film of the polymer adhering to the surface of the composite. The hybrid membrane is subsequently dried and rolled up. Depending on the particular support which is used, this operation has to be repeated one or more times. In one particular embodiment, the composite may also be guided past the polymer film from above, although in that case somewhat thicker films are frequently obtained.

The polymer films on the surface of a fluid can be produced, for example, by dissolving the polymer of the selective layer of the hybrid membranes in a water-insoluble solvent in a concentration of from 0.1 to 5% and applying this solution to a water surface. Following evaporation of the solvent, a very thin gastight film is obtained which floats on the surface of the water and can then be applied to the membrane by the process described above.

Production of polymer films by interface condensation takes place in accordance with the prior art. Normally, the two components for condensation are charged in two mutually immiscible solvents to a vessel, so that the polymer film is formed at the interface between these two solvents and also keeps on forming as soon as part of the film is removed.

The hybrid membranes of the invention find application in many sectors. Owing to the possibility of tailoring the selective layer to a particular separation, advantages arise in gas permeation, pervaporation, nanofiltration, and ultrafiltration. Application as a membrane reactor, even at relatively high temperatures, is also easy to conceive of.

The hybrid membranes of the invention can therefore be used, for example, as the membrane in pressure-operated membrane processes, in nanofiltration, in reverse osmosis or in ultrafiltration.

The hybrid membranes of the invention can also be used in pervaporation or in vapor permeation and also as the membrane in a membrane reactor.

The use of a hybrid membrane of the invention, especially a hybrid membrane which has a gastight separating layer, as the membrane in gas separation is a further possibility.

The advantages of the hybrid membranes of the invention lie above all in the greater stability of the membranes at high pressures, at high temperatures or in solvents and acids and bases. In the case of gas separation, it is the greater stability at high pressures which is exploited, since the hybrid membranes of the invention are more stable and do not undergo compaction at pressures of up to 40 bar. In pervaporation and vapor permeation, it is the better stabilities toward a wide variety of organic solvents, and the enhanced temperature stability, which are exploited. Filtration applications likewise exploit the greatly improved pressure stability, since at pressures of from 20 to 100 bar in nanofiltration applications the majority of polymer membranes undergo severe compaction and hence the flows through the membrane are markedly lower than would be the case solely on the basis of the selective separating layer.

As a result of the flexibility of the hybrid membrane of the invention, which exists in spite of the ceramic support, and the low thickness of said membrane, it is able to enter into applications which hitherto were accessible only to the soft and flexible polymer membranes or membranes of polymer with inorganic fillers.

The examples below are intended to illustrate the hybrid membranes of the invention and also the process for producing such hybrid membranes, without any intention that the invention should be restricted to these embodiments.

### EXAMPLE 1a

### Production of an S100PAN Composite

15 g of 5% strength by weight aqueous HCl, 10 g of tetraethoxysilane, 2.5 g of methyltriethoxysilane and 7.5 g of Dynasilan GLYMO (Degussa AG) are added first of all to 160 g of ethanol. In this sol, which initially has been stirred for more than 4 hours more, 300 g of the aluminum oxide AlCoA CT3000 are suspended. This slip is homogenized using a magnetic stirrer for at least 24 hours more, during which it is necessary to cover the stirring vessel so that there is no loss of solvent.

A PAN web (Viledon 1773 from Freudenberg) with a thickness of approximately 100 μm and a basis weight of 22 g/m² is coated with the above slip in a continuous roller application process (belt speed about 8 m/h, T=250° C.). With this roller application process, the slip is rolled onto the web using a roll which moves in the direction opposite to that of the belt (the direction in which the web is moving). The web then passes through an oven which is at the stated temperature. The same method and setup are used in the experiments below. The final result is a microfiltration membrane having an average pore width of 100 nm.

### EXAMPLE 1b

### Production of an S100PET Composite

15 g of 5% strength by weight aqueous HCl, 10 g of tetraethoxysilane, 2.5 g of methyltriethoxysilane and 7.5 g of Dynasilan GLYMO are added first of all to 160 g of ethanol. In this sol, which initially has been stirred for more than 4 hours more, 280 g of the aluminum oxide AlCoA CT3000 are suspended. This suspension is homogenized using a magnetic stirrer for at least 24 hours more, during which it is necessary to cover the stirring vessel so that there is no loss of solvent.

A PET web with a thickness of approximately 30 μm and a basis weight of 20 g/m² is coated with the above suspension in a continuous roller application process (belt speed about 8 m/h, T=200° C.). The final result is a microfiltration membrane having an average pore width of 100 nm.

### EXAMPLE 2a

A coating unit comprising a recoating system, a dryer, and a winder is fed with an inorganic flexible composite from example 1a as the material to be coated. The recoating system applies a layer approximately 50 μm thick of a PDMS solution to the composite, which is then dried in a drying oven at 110° C. The web speed was 1.0 m/min. After drying, the membrane was rolled up again and processed further. The coating solution consisted of 8.5% by weight of PDMS, 1.37% by weight of crosslinker and 0.084% by weight of a catalyst in THF. The products used were the following chemicals, available from Wacker: Dehesive 930 as PDMS component, crosslinker V93, and the catalyst Ol. A gastight hybrid membrane was obtained which can be used for gas separation and which possesses an N₂/O₂ selectivity of 2.1 (determined from the pure-gas permeabilities).

### EXAMPLE 2b

The membrane obtained in accordance with example 2a is irradiated in a subsequent step with a radiation dose of 69 kGy from a low-energy accelerator of the LEA type (Institut für Oberflächenmodifizierung Leipzig e.V.) under an air atmosphere. This gave a PDMS membrane which is insolubly crosslinked in organic solvents, has no delamination tendencies at all, and can be used not only for gas separation but also in nanofiltration in organic solvents. The cutoff (determined using polystyrene as a 1% strength solution in cyclohexane, the respective molar weight distributions being determined by means of gel permeation chromatography) of this membrane is 10 000 g/mol.

### EXAMPLE 2c

A piece of a composite obtained in accordance with example 1b and of approximately DIN A4 size was treated with a PVA solution by dip coating. The solution consists of 2.5% of polyvinyl alcohol and 1.0% of β-cyclodextrin in an aqueous sodium hydroxide solution with a pH of 9. After coating, the membrane is crosslinked at 150° C. for about 1 hour and can then be used in pervaporation. For a more precise description of the substances used, see DE 199 25 475 A1.

### EXAMPLE 2d

A piece of a composite obtained in accordance with example 1a of approximately DIN A4 size was provided with a coating of cis-polyisoprene (from Aldrich) by preparing a 2.5% strength solution of the polymer in toluene. This solution was applied to a water surface, the water used having been degassed beforehand. Following evaporation of the solvent, this film was applied to the composite produced in accordance with example 1a by guiding said composite carefully from below onto the polymer film, with the film then attaching to the composite. After drying at 100° C., the separation factor was determined, from the pure-gas permeabilities of oxygen and nitrogen, as having a value of 3.1.

### EXAMPLE 2e

A 5% strength by weight solution of adipoyl dichloride (from Merck) in chloroform is placed in a dish and is carefully overlayered with a thin layer of an aqueous and weakly basic 5% strength by weight solution of hexamethylenediamine (from Merck). A polymer film is formed immediately at the interface between the two phases. This polymer film is applied to a composite in accordance with example 1a by guiding the composite slowly from above (using a roller with a 180° wrapround) onto the surface of the polymer layer and then slowly transporting the composite further on the phase boundary. The composite guided out of the dish, finished with a polymer layer, is subsequently dried at 120° C. The polymer layer is reformed immediately as the polymer layer is transported away with the roller on the composite.

### EXAMPLE 2f

A coating solution as described in example 2a is admixed with a further 14% by weight of a very low-aluminum zeolite Y (from Zeolyst). The membrane produced with this solution in accordance with example 2a was subsequently characterized by means of a sorption experiment. In the course of this experiment it was found that as compared with example 2a this membrane exhibited a sorption for n-hexane which was higher by 50%. (This was determined by monitoring the weights of the membranes when the specimens were stored in a saturated atmosphere.) A 50% increase in sorption always results in a marked increase in the flow (also called permeability) for this component.

### EXAMPLE 3a

A membrane produced in accordance with example 2b was used in order to retain polystyrene having a molar mass of from 2 000 g/mol to 100 000 g/mol. The polystyrene was present in tetrahydrofuran solvent. The retention rate was 99.2% with a material flow of 10 L m⁻² h⁻¹ bar⁻¹ at a pressure of 20 bar. The retention rate of a comparative ceramic nanofiltration membrane was much lower, at 92%. For this membrane the manufacturer had specified a pore radius of 1 nm, which ought to correspond to a cutoff of approximately 500 g/mol. Solvent-resistant polymeric nanofiltration membranes also always had a retention of >99% at the beginning. However, this retention rate fell over time (after 2 days) to levels of less than 90% retention. This always went hand in hand with a marked drop in flow.

### EXAMPLE 3b

A membrane produced as in example 2a was employed for the same separation as in example 3a. The polymeric layer dissolved very rapidly, and no separation was observed.

### EXAMPLE 3c

A membrane produced as in example 2b was employed for the same separation as in example 3a. In contrast to example 2b a composite obtained in accordance with example 1a was used, but using a PVDF web instead of the PAN web. The retention rate was 98% for a material flow of 3 L m⁻² h⁻¹ bar⁻¹.

### EXAMPLE 3d

A membrane produced as in example 2b was used for the same separation as in example 3a. In contrast to example 2b a composite obtained in accordance with example 1a was used, the composite being produced not the PAN web but instead a polyolefin web made of polyethylene and polypropylene fibers (FS 2202-03 from Freudenberg) having a thickness of approximately 30 μm. The retention rate was 98% for a material flow of 3 L m⁻² h⁻¹ bar⁻¹. However, this rate deteriorated after 48 hours, since the support material was slowly attacked by the solvent.

### EXAMPLE 3e

A membrane produced in accordance with example 2c was used for separating water and acetonitrile in pervaporation at 70° C. The flow of water was 0.24 kg m⁻² h⁻¹ with a separation factor of 2 300.

### EXAMPLE 3f

A membrane produced in accordance with example 2e is characterized in terms of its cutoff by means of a polyethylene glycol mixture. The cutoff is 370 g/mol for a flow of 10 kg m⁻² h⁻¹. Even after this membrane has been run for a relatively long period of 125 hours at more than 50 bar pressure, no drop in flow can be measured.

### COMPARATIVE EXAMPLE

A membrane produced in accordance with example 2c using a polyethylene (PE) support (manufacturer: Cellgard) instead of the composite was used for separating water and acetonitrile in pervaporation at 70° C. The flow of water was 0.14 kg m⁻² h⁻¹ with a separation factor of 2 390, with a further increase in flow being observable over the subsequent 3 hours.

It is evident that a decrease in flow is observed after a relatively short time in the case of pure polymer membranes. This is probably due to the progressive compaction of these membranes. The membranes of the invention exhibit very little decrease in flow, if any. This is probably due to the presence of the ceramic coating, which (very substantially) prevents compaction of the hybrid membrane.

1. A hybrid membrane having a selective separating layer and comprising a permeable composite and polymeric material, wherein the membrane is flexible and the selective separating layer is formed by a polymeric material and is applied as a layer comprising an organic polymer to the composite, the polymer layer having a thickness of from 0.1 to 10 μm, and the composite is based on a permeable substrate which comprises polymer fibers having a diameter of from 1 to 25 μm and on which and in which there are inorganic components as a ceramic coating.

2. The membrane as claimed in claim 1, wherein the substrate comprising polymer fibers comprises a woven fabric, a knit and/or a web.

3. The membrane as claimed in claim 2, wherein the substrate comprising polymer fibers is a web.

4. The membrane as claimed in claim 1, wherein the polymer fibers comprise polymers selected from polyacrylonitrile, polyamides, polyimides, polyacrylates, polytetrafluoroethylene, polyesters and/or polyolefins or mixtures of these polymers.

5. The membrane as claimed in claim 1, wherein the ceramic composite is based on a permeable substrate which comprises polymer fibers and on which and/or in which a suspension of an inorganic component and a sol has been solidified.

6. The membrane as claimed in claim 1, wherein the composite has a thickness of less than 200 μm.

7. The membrane as claimed in claim 1, wherein the substrate has a thickness of from 30 to 100 μm.

8. The membrane as claimed in claim 1, wherein the inorganic composite comprises an oxide selected from Al₂O₃, TiO₂, ZrO₂, and SiO₂.

9. The membrane as claimed in claim 1, wherein the selective separating layer is a gastight polymer layer.

10. The membrane as claimed in claim 9, wherein the gastight polymer layer is composed of polydimethylsiloxane (PDMS), polyvinyl alcohol, methyl-cellulose, polyurethane, polyester, polyether, polyamide, polyimide or cellulose acetate.

11. The membrane as claimed in claim 9, wherein the gastight polymer layer has a thickness of from 0.2 to 5 μm.

12. The membrane as claimed in claim 9, wherein the gastight polymer layer comprises inorganic adjuvants.

13. The membrane as claimed in claim 1, which can be bent without damage by a radius of down to 100 m.

14. A process for producing a hybrid membrane as claimed in claim 1 having a selective polymeric separating layer comprising a composite which comprises a flat, multiapertured, flexible substrate having a coating on and in said substrate, the material of the substrate being selected from woven and/or nonwoven fibers of polymers and the coating being a porous ceramic coating, which comprises applying a layer comprising an organic polymer to the composite, this layer being formed by applying a solution of an organic polymer to the inorganic composite and removing the solvent, or being produced by means of interface polycondensation or on a surface of fluids.

15. The process as claimed in claim 14, wherein the composite is produced by applying a suspension comprising at least one oxide of the metals Al, Zr, Si, Sn, Ti and/or Y and a sol to the substrate and by heating the coated substrate at least once, during which the suspension is solidified on the composite.

16. The process as claimed in claim 14, wherein the suspension is applied on and in the substrate by printing, pressing, injecting, rolling, knife coating, spreading, dipping, spraying or pouring.

17. The process as claimed in claim 14, wherein the suspension which comprises at least one inorganic component and at least one sol, at least one semimetal oxide sol or at least one mixed metal oxide sol or a mixture of these sols is prepared by suspending at least one inorganic component in at least one of said sols.

18. The process as claimed in claim 14, wherein the sols are obtained by hydrolyzing at least one metal compound, at least one semimetal compound or at least one mixed metal compound with water, steam, ice, alcohol or an acid or a combination of these compounds.

19. The process as claimed in claim 18, wherein at least one metal alkoxide compound or at least one semimetal alkoxide compound selected from the alkoxide compounds of the elements Ti, Zr, Al, Si, Sn and Y or at least one metal nitrate, metal carbonate or metal halide selected from the metal salts of the elements Ti, Zr, Al, Si, Sn and Y is hydrolyzed as the metal compound.

20. The process as claimed in claim 15, wherein at least one oxide selected from the oxides of the elements Zr, Al, Sn, Y, Ti and Si is suspended as the inorganic component and the mass fraction of the suspended components corresponds to from 0.1 to 500 times that of the sol which is used.

21. The process as claimed in claim 15, wherein the suspension applied to the composite is solidified by heating at from 50 to 350° C.

22. The process as claimed in claim 21, wherein said heating takes place at a temperature from 110 to 280° C. for from 0.5 min to 10 min.

23. The process as claimed in claim 14, wherein the solution comprises at least one polymer selected from polydimethylsiloxane (PDMS), polyvinyl alcohol, methylcellulose, polyamide, polyimide, polyether, polyurethane, polyester or copolymers, including block copolymers, of these polymers or cellulose acetate or a polymer blend which comprises at least one of said compounds.

24. The process as claimed in claim 14, wherein the solvent is removed at a temperature from 50 to 350° C.

25. The process as claimed in claim 14, wherein the polymer of the polymer layer is chemically modified by a temperature treatment.

26. A process, which comprises:
contacting a liquid with the claim 1, and
applying pressure to the liquid.

27. A nanofiltration, reverse osmosis, ultrafiltration or microfiltration process, which comprises:
contacting at least one liquid with the hybrid membrane as claimed in claim 1.

28. A pervaporation or vapor permeation method, which comprises:
contacting a vapor with the hybrid membrane as claimed in claim 1.

29. A membrane reactor, comprising
the hybrid membrane as claimed in claim 1.

30. A gas separation method which comprises:
contacting a gas with the hybrid membrane as claimed in claim 1.
